(19) United States
(12) Patent Application Publication
(10) Pub. No.: US 2018/0134498 A1
(43) Pub. Date: May 17, 2018

(54) WORKPIECE FEEDING DEVICE AND WORKPIECE REMOVING DEVICE

(71) Applicant: HOMAG GMBH, Schopfloch (DE)

(72) Inventors: Gordian SCHMID, Bad Rippoldsau-Schapbach (DE); Volker SCHMIEDER, Mössingen (DE)

(73) Assignee: HOMAG GMBH, Schopfloch (DE)

(21) Appl. No.: 15/572,607

(22) PCT Filed: Apr. 29, 2016
(86) PCT No.: PCT/EP2016/059631

§ 371 Date: Nov. 8, 2017

(30) Foreign Application Priority Data
May 8, 2015 (DE) 10 2015 208 618.6

(51) Int. Cl. B65G 43/08

(52) U.S. Cl. CPC B65G 43/08

(57) ABSTRACT

The invention relates to a workpiece feeding device having at least two workpiece receiving positions for a workpiece to be laid in the respective workpiece receiving position, and having at least one workpiece removal position for the removal of a workpiece, having workpiece conveying means for conveying workpieces that have been laid on in a conveying direction from the at least one workpiece receiving position to one of the workpiece removal positions, wherein at least one signaling means is provided for signaling a selected workpiece receiving position in which a workpiece can be laid. The invention further relates to a workpiece removal device and to related methods.

### TECHNICAL FIELD

The invention relates to a workpiece feed device, in particular for feeding workpieces to a processing device, in particular for processing workpieces of wood, wood-based materials, plastic or the like. The invention also relates to a workpiece discharge device, in particular for discharging workpieces from a corresponding processing device. The invention also relates to a method for operating such a workpiece feed device and a method for operating such a workpiece discharge device.

### PRIOR ART

The workpiece feed device and/or the workpiece discharge device serve/serves to feed workpieces to and/or discharge workpieces from a processing device for processing workpieces, in particular for processing workpieces of wood, wood-based material, plastic of the like. Such processing devices usually have a workpiece table, having a workpiece holder by means of which a workpiece can be arranged and held, at least temporarily, in order for the workpiece to be processed while being held. Such workpiece tables having workpiece holders may be realized so as to be substantially stationary or movable by means of advancing means. If the workpiece table having the workpiece holder is of a substantially stationary design, the tool for processing the workpiece may then be brought to the workpiece itself, in order to effect processing of the workpiece as a result of a generated relative motion of the workpiece and the tool. As an alternative to this, or also additionally, if the workpiece table having the workpiece holder is of a substantially movable design, the workpiece to be processed can be brought to the tool itself, in order to effect processing of the workpiece as a result of a generated relative motion of the workpiece and the tool. For this purpose, the processing device may have, for example, a stationary or movable portal, or a stationary or movable boom or similar, on which the tool for processing the workpiece, again stationary or displaceable, can be guided, to enable the intended processing operations to be performed on the workpiece, together with any displacement of the workpiece. In this case, the workpiece may either be guided past the tool or vice versa, or both the workpiece and the tool may be displaced during the processing operation, such that a selective relative motion is provided between the tool and the workpiece, to enable the workpiece to be processed, for example, along one side or edge.

In the case of processing devices according to the prior art, the workpieces, before being processed, must be fed to the processing device, such that the workpieces can be processed in an automated manner by the processing device. Such processed workpieces must also then be discharged again from the processing device, such that the workpieces that have been processed make room on the processing device for workpieces that are still to be processed. Workpiece feed devices and workpiece discharge devices are provided for this purpose.

In the case of present-day workpiece feed devices and workpiece discharge devices, workpieces are fed serially in succession and discharged again serially, such that the workpieces to be processed have to be loaded in succession onto the workpiece feed device, and the processed workpieces have to be taken away in succession from the workpiece discharge device, by the worker at the machine.

In some instances, however, in the case of an increase in the processing capacity of the processing device, it is already the case that a plurality of quite possibly individual workpieces are received and processed adjacently in the processing device, such that the sequence of feed of the individual workpieces is important for accurate processing. The same applies to the discharge and subsequent handling of customized workpieces. Here, likewise, the sequence of removal of the individual workpieces is important, in order that the latter are subsequently handled correctly.

### PRESENTATION OF THE INVENTION, OBJECT, ACHIEVEMENT OF THE OBJECT, ADVANTAGES

It is the object of the invention to create a workpiece feed device and a workpiece discharge device that are of a simple construction and that nevertheless allow workpieces to be handled in a safe manner. It is also the object of the present invention to create a method, for operating such a workpiece feed device or workpiece discharge device, that allows the workpieces to be handled in a simple and safe manner.

The object relating to the workpiece feed device is achieved by the features of claim 1.

An exemplary embodiment of the invention relates to a workpiece feed device having at least two workpiece receiving positions for loading a workpiece in the respective workpiece receiving position, and having at least one workpiece removal position for removing a workpiece, having workpiece conveying means for conveying loaded workpieces in a conveying direction from the at least one workpiece receiving position to one of the workpiece removal positions, wherein at least one signal means is provided for signaling a selected workpiece receiving position in which a workpiece can be loaded. It can thereby be signaled to the worker, on the basis of the previously determined processing program, which workpiece the worker is to load onto which workpiece receiving position, so that the workpieces are received, transported and, for example, transferred to a processing device, in order that they can be also be processed correctly in accordance with the specifications. The workpiece feed device in this case may have a workpiece removal position, onto which the workpieces can be brought irrespective of their workpiece receiving position, or the workpiece feed device my have more than one workpiece removal position, into which the workpieces can be brought, for example, in dependence on their workpiece receiving position.

It is particularly advantageous if the at least two workpiece receiving positions are arranged adjacently to each other in a direction perpendicular to the conveying direction. The at least two workpieces can thereby be loaded and conveyed onward next to each other in their longitudinal direction. These at least two workpieces can thus be conveyed next to each other to a workpiece removal position, where they are removed together and fed to a processing device, such that they can be processed in an optimized manner, which can increase the capacity of the processing device.

According to a further aspect of the invention, it is advantageous if there is assigned to at least one workpiece receiving position, or to each apart from one workpiece receiving position, or to each workpiece receiving position, a signal means that can be activated to indicate that a workpiece can be loaded into the assigned workpiece receiving position. The signal means in this case may be provided in such a manner that the workpiece receiving position of the loading is indicated. Thus, a signal means that can be activated may be assigned to each workpiece receiving position. Also, in the case of a plurality of workpiece receiving positions, a signal means may be assigned, for example, only to the second workpiece receiving position and the subsequent workpiece receiving positions, which may mean that, if nothing is indicated, the first workpiece receiving position is to be occupied. Also, a signal means may be assigned to a specially selected workpiece receiving position that should be occupied in the case of specific workpieces, the other available workpiece receiving positions otherwise being freely selectable.

It is particularly advantageous if the signal means has a stop means that can be extended to indicate that a workpiece can be loaded into the workpiece receiving position assigned to the stop means. The position of the workpiece can thereby be defined, in that the workpiece can be loaded on the stop means. If the stop means is not extended, the workpiece, advantageously, is also not loaded there, but at a different workpiece receiving position. In this case, the stop means may also be, for example, permanently extended or arranged at a workpiece receiving position, such that the workpiece can be loaded there if no other workpiece receiving positions are indicated.

According to the concept of the invention, it is furthermore advantageous if the signal means has an optical and/or acoustic signal means, by means of which a selected workpiece receiving position can be indicated to indicate that a workpiece can be loaded into the workpiece receiving position indicated by the signal means. By means of the acoustic or optical signal means it is possible to indicate directly where the workpiece, in particular the next workpiece, can be loaded. The sequence and the position of the workpiece can thereby be indicated to the worker, this being preprogrammable in dependence on the predefined sequence of workpiece processing.

The object relating to the workpiece discharge device is achieved by the features of claim 6.

An exemplary embodiment of the invention relates to a workpiece discharge device having at least one workpiece receiving position for loading a workpiece in the respective workpiece receiving position, and having at least two workpiece removal positions for removing a workpiece, having workpiece conveying means for conveying loaded workpieces in a conveying direction from the at least one workpiece receiving position to one of the workpiece removal positions, wherein at least one signal means is provided for signaling a selected workpiece removal position from which a workpiece can be removed. Thus, for example, a workpiece can be loaded by an manipulator of a processing device onto the workpiece discharge device and discharged by the latter. If there are two, or more than two, workpiece receiving positions, then indeed more than one workpiece can also be loaded simultaneously on the workpiece discharge device and taken away. After that, one of the workpieces lying next to each other in the workpiece removal positions can then be removed by the worker, the workpiece to be removed being indicated by means of the signal means.

It is advantageous in this case if the at least two workpiece removal positions are arranged adjacently to each other in a direction perpendicular to the conveying direction. This achieves the effect that the workpiece removal positions allow parallel discharge, it then being indicated to the worker which workpiece is to be removed from which workpiece removal position, and also in which sequence.

It is also advantageous if there is assigned to at least one workpiece removal position, or to each apart from one workpiece removal position, or to each workpiece removal position, a signal means that can be activated to indicate that a workpiece can be removed from the assigned workpiece removal position. This makes it possible to signal in an unambiguous manner which workpiece is to be removed next by a worker.

It is advantageous in this case if the signal means has a stop means that can be retracted or extended to indicate that a workpiece can be removed from the workpiece removal position assigned to the stop means. The stop means may thus be provided to block the transport of the workpieces, and it is possible to indicate, for example by lowering of the stop means, which workpiece is to be removed.

It is also advantageous if the signal means has an optical and/or acoustic signal means, by means of which a selected workpiece removal position can be indicated to indicate that a workpiece can be removed from the workpiece removal position indicated by the signal means. It can also thereby be indicated which workpiece removal position is selected for removal.

Provided according to a further aspect of the invention is a workpiece transport device, having a workpiece feed device according to the invention and/or having a workpiece discharge device according to the invention. The workpiece feed device may thus be provided by itself or in combination with a workpiece discharge device. Likewise, the workpiece discharge device may be provided by itself or in combination with a workpiece feed device.

The object relating to the method for operating a workpiece feed device is achieved by the features of claim 12.

An exemplary embodiment of the invention relates to a method for operating a workpiece feed device having at least two workpiece receiving positions for loading a workpiece in the respective workpiece receiving position, and having at least one workpiece removal position for removing a workpiece, having workpiece conveying means for conveying loaded workpieces in a conveying direction from the at least one workpiece receiving position to one of the workpiece removal positions, wherein at least one signal means is provided and controlled to indicate a selected workpiece receiving position in which a workpiece is to be loaded.

It is advantageous in this case if the signal means has a stop means that is extended to indicate that a workpiece is to be loaded into the workpiece receiving position assigned to the stop means.

It is also advantageous if the signal means has an optical and/or acoustic signal means that is activated to indicate that a workpiece is to be loaded into the workpiece receiving position indicated by the signal means.

The object relating to the method for operating a workpiece discharge device is achieved by the features of claim 15.

An exemplary embodiment of the invention relates to a method for operating a workpiece discharge device having at least one workpiece receiving position for loading a workpiece in the respective workpiece receiving position, and having at least two workpiece removal positions for removing a workpiece, having workpiece conveying means for conveying loaded workpieces in a conveying direction from the at least one workpiece receiving position to one of the workpiece removal positions, wherein at least one signal means is provided and controlled for signaling a selected workpiece removal position from which a workpiece is to be removed.

It is advantageous in this case if the signal means has a stop means that is retracted or extended to indicate that a workpiece is to be removed from the workpiece removal position assigned to the stop means.

It is also advantageous if the signal means has an optical and/or acoustic signal means that is controlled to indicate that a workpiece is to be removed from the workpiece removal position indicated by the signal means.

Further advantageous designs are described by the following description of the figures and by the dependent claims.

### BRIEF DESCRIPTION OF THE DRAWINGS

The invention is explained in greater detail in the following, with reference to the drawing, on the basis of at least one exemplary embodiment. There are shown:

FIG. 1 a schematic representation of a combined workpiece feed device and workpiece discharge device, in particular of a processing device for workpieces,

FIG. 2 a schematic representation of a workpiece feed device and a workpiece discharge device in a case of operation, and

FIG. 3 a schematic representation of a workpiece feed device and a workpiece discharge device in another case of operation.

### PREFERRED EMBODIMENT OF THE INVENTION

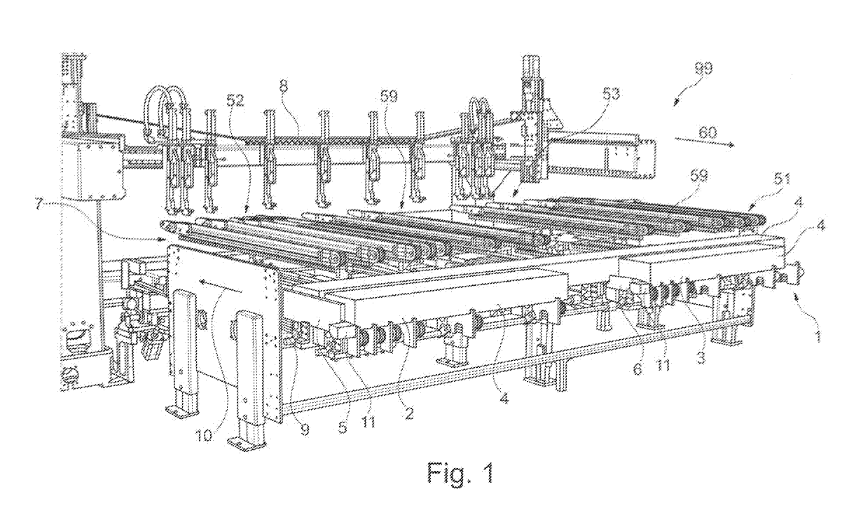

FIGS. 1, 2 and 3 shows a workpiece feed device and a workpiece discharge device for a processing device, in particular for processing workpieces of wood, wood-based materials, plastic or the like. The workpieces in this case may be, for example, somewhat elongate, beam-type workpieces, or somewhat flat, somewhat two-dimensional, board-type workpieces. Advantageously in this case, the workpieces can be fed along the longitudinal direction of a workpiece table of the processing device. Alternatively, it would also be possible for the workpieces to be fed in another orientation.

The processing device in this case advantageously has a workpiece table, having a workpiece holder that has clamping elements, for clamping at least one workpiece or a plurality of workpieces, by means of which the workpiece or the workpieces can be held securely for processing. The workpiece table is preferably realized such that it is connected to an advancing unit, by means of which the workpiece table can be displaced, at least in one direction.

Additionally provided is a workpiece manipulator, which serves to feed a workpiece or a plurality of workpieces from the workpiece feed device to the workpiece holder of the workpiece table, and to place the workpiece or the workpieces on the workpiece table. The manipulator also serves, for example, to feed the workpiece or the workpieces from the workpiece table to the workpiece discharge device, so that the workpiece or workpieces can be discharged.

FIGS. 1 to 3 each show a workpiece feed device 1 and workpiece discharge device 51, which are arranged over one another. The workpiece discharge device 51 is arranged above the workpiece feed device 1. Also possible, in principle, is a different relative arrangement of the workpiece feed device 1 in relation to the workpiece discharge device 51. FIGS. 1 to 3 shows that the workpiece feed device 1 and a workpiece discharge device 51 are realized as a structural unit, such that a combined workpiece transport device 99 is formed.

The workpiece feed device 1 in this case advantageously has at least two workpiece receiving positions 2, 3, for loading a workpiece 4 in the respective workpiece receiving positions 2, 3. It is shown in FIG. 1 that there are two workpieces 4, disposed next to each other in their longitudinal direction, in a rearmost row. In a second row arranged in front of the latter, there is only one workpiece 4 arranged in the first workpiece receiving position 2. The workpiece 4 of the second row is longer than the workpieces 4 of the first row.

Provided for the purpose of loading the workpieces 4 in the respective workpiece receiving position 2, 3 there are stop means 5, 6, against which the workpieces 4 can be laid, respectively, such that they are positioned correctly. The stop means 5 in this case is advantageously mounted in a fixed manner, such that it is always present, and projects in order that a workpiece can be loaded. The stop means 6 is realized, advantageously, such that it can be raised and lowered, such that it can be raised if necessary and, alternatively, can also be lowered when not in use. In FIG. 1, the stop means 6 is raised, such that the workpiece 4 can be laid against this stop means.

Furthermore, the workpiece feed device 1 has at least one workpiece removal position 7, into which a workpiece can be conveyed, or transported, so as to be removable from this workpiece removal position 7 in order that the workpiece 4 can be processed further. The at least one workpiece removal position 7, advantageously there may also be at least two such workpiece removal positions 7, is for removal of a workpiece 4, for example by means of a manipulator 8, in particular to enable the workpiece 4 to be fed to a workpiece table.

The workpiece feed device 1 has workpiece conveying means 9, for conveying loaded workpieces 4 in a conveying direction 10 from the at least one workpiece receiving position 2, 3 to one of the workpiece removal positions 7.

The workpiece feed device 1 has at least one signal means 11, for signaling a selected workpiece receiving position 2, 3 in which a workpiece 4 can be loaded. The workpiece receiving position 2, 3 that is selected for the next workpiece, and into which the next workpiece is to be loaded, is indicated by means of the signal means.

It is advantageous in this case if there is assigned to at least one workpiece receiving position 2, 3, or to each apart from one workpiece receiving position 2, 3, or to each workpiece receiving position 2, 3, a signal means 11 that can be activated to indicate that a workpiece 4 can be loaded into the assigned workpiece receiving position 2, 3.

The signal means 11 in this case may also be realized as a stop means 6 that can be extended to indicate that a workpiece 4 can be loaded into the workpiece receiving position 3 assigned to the stop means 6.

Alternatively or additionally, the signal means 11 may have an optical and/or acoustic signal means, by means of which a selected workpiece receiving position 2, 3 can be indicated, to indicate that a workpiece 4 can be loaded into the workpiece receiving position 2, 3 indicated by the signal means 11. The signal means in this case may be a lamp, a light fixture, a screen, a display, etc. Also, as an alternative or in addition to an optical indication, acoustic signaling may be effected.

FIG. 1 shows that the at least two workpiece receiving positions 2, 3 are disposed adjacently to each other in a direction perpendicular to the conveying direction 10. The signaling of the signal means selects, respectively, the workpiece receiving position 2, 3 to which a worker is to assign a workpiece. The assignment in this case depends, for example, on the processing program, the dimensions of the workpiece, etc.

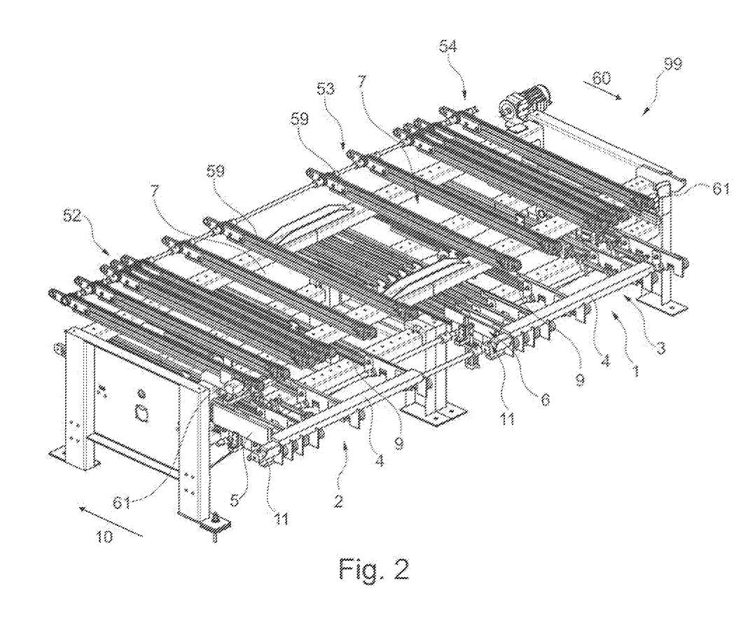

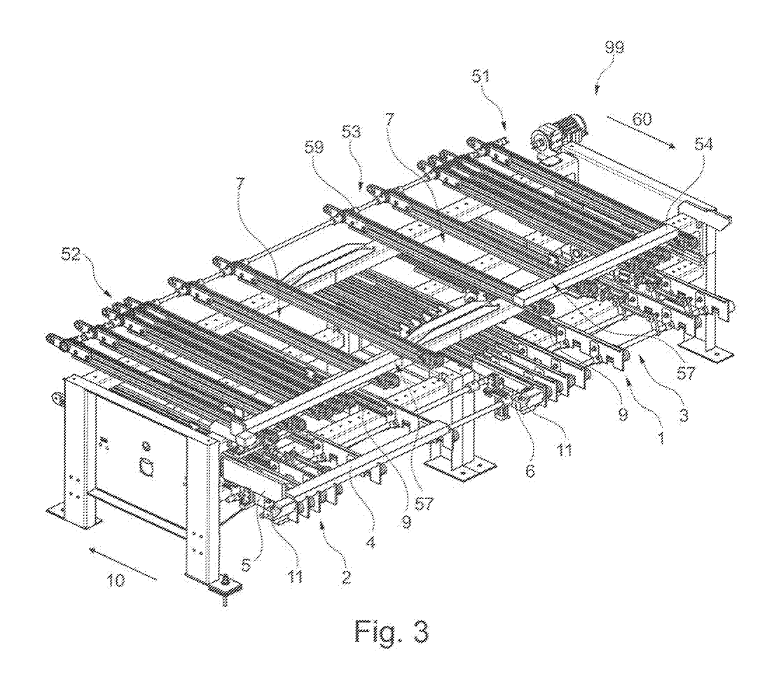

FIG. 2 shows the stop means 6 having been extended by actuator means, to enable a workpiece 4 to be loaded there. FIG. 3 shows the stop means 6 having been lowered, so that a workpiece cannot be loaded there.

The workpiece discharge device 51 in this case advantageously has at least one workpiece receiving positions 52, advantageously also more than one workpiece receiving position 52, 53, for loading a workpiece 54 in the respective workpiece receiving position 52, 53. It is shown in FIG. 3 that there are two workpieces 54 arranged next to each other in their longitudinal direction, which are discharged simultaneously.

Stop means may be provided for laying the workpieces 54 in the respective workpiece receiving position 52, 53. In the case of an automated discharge, however, for example from a workpiece table, this may also be effected in a correctly positioned manner without stops, by means of a manipulator 8.

Furthermore, the workpiece discharge device 51 has at least one, advantageously more than one, workpiece removal position 57, into which a workpiece 54 can be conveyed, or transported, so as to be removable from this workpiece removal position 57 in order that the workpiece 54 can be handled further. The at least one workpiece removal position 57, advantageously there may also be at least two such workpiece removal positions 57, is for removal of a workpiece 54.

The workpiece discharge device 51 also has workpiece conveying means 59, for conveying loaded workpieces 54 in a conveying direction 60 from the at least one workpiece receiving position 52, 53 to one of the workpiece removal positions 57.

The workpiece discharge device 51 has at least one signal means 61, for signaling a selected workpiece removal position 57 from which a workpiece 54 can be removed. The workpiece removal position 57 from which the next workpiece is to be removed is indicated by means of the signal means 61.

It is advantageous in this case if there is assigned to at least one workpiece removal position 57, or to each apart from one workpiece removal position 57, or to each workpiece removal position 57, a signal means 61 that can be activated to indicate that a workpiece 54 can be removed from the assigned workpiece removal position 57.

The signal means 61 in this case may also be realized as a stop means that can be retracted, at least partly, to indicate that a workpiece 54 can be removed from the workpiece removal position 57 assigned to the stop means.

Alternatively or additionally, the signal means 61 may also have an optical and/or acoustic signal means, by means of which a selected workpiece removal position 57 can be indicated to indicate that a workpiece 54 can be removed from the workpiece removal position 57 indicated by the signal means 61. The signal means in this case may be a lamp, a light fixture, a screen, a display, etc. Also, as an alternative or in addition to an optical indication, acoustic signaling may be effected.

FIG. 3 shows that the at least two workpiece removal positions 57 are disposed adjacently to each other in a direction perpendicular to the conveying direction 60. The signaling of the signal means 61 selects, respectively, the workpiece removal position 57 from which a worker must remove a workpiece 54. The removal in this case depends on the workpiece 54 itself and on the further handling thereof.

The workpiece conveying means 9, 59 advantageously have belt and/or chain conveying mechanisms, having a plurality of revolving belts and/or chains, and/or a plurality of rollers, by means of which workpieces 4, 54 can be transported in a conveying direction 10, 60.

The method according to the invention provides that an above-mentioned workpiece feed device, having at least two workpiece receiving positions for loading a workpiece in the respective workpiece receiving position, and having at least one workpiece removal position for removing a workpiece, is operated, wherein workpiece conveying means, for conveying loaded workpieces in a conveying direction from the at least one workpiece receiving position to one of the workpiece removal positions, are provided, and wherein at least one signal means is provided and controlled to indicate a selected workpiece receiving position in which a workpiece is to be loaded.

The method according to the invention also provides, alternatively, that an above-mentioned workpiece discharge device, having at least one workpiece receiving position for loading a workpiece in the respective workpiece receiving position, and having at least two workpiece removal positions for removing a workpiece, is operated, wherein workpiece conveying means, for conveying loaded workpieces in a conveying direction from the at least one workpiece receiving position to one of the workpiece removal positions, are provided, wherein at least one signal means is provided and controlled for signaling a selected workpiece removal position from which a workpiece is to be removed.

### List of References

1 workpiece feed device

2 workpiece receiving position

3 workpiece receiving position

4 workpiece

5 stop means

6 stop means

7 workpiece removal position

8 manipulator

9 workpiece conveying means

10 conveying direction

11 signal means

51 workpiece discharge device

52 workpiece receiving position

53 workpiece receiving position

54 workpieces

57 workpiece removal position

59 workpiece conveying means

60 conveying direction

61 signal means

99 workpiece transport device

1. A workpiece feed device having at least two workpiece receiving positions for loading a workpiece in the respective workpiece receiving position, and having at least one workpiece removal position for removing a workpiece, having workpiece conveying means for conveying loaded workpieces in a conveying direction from the at least one workpiece receiving position to one of the workpiece removal positions, wherein at least one signal means is provided for signaling a selected workpiece receiving position in which a workpiece can be loaded.

2. The workpiece feed device as claimed in claim 1, wherein the at least two workpiece receiving positions are arranged adjacently to each other in a direction perpendicular to the conveying direction.

3. The workpiece feed device as claimed in claim 1, wherein there is assigned to at least one workpiece receiving position, or to each apart from one workpiece receiving position, or to each workpiece receiving position, a signal means that can be activated to indicate that a workpiece can be loaded into the assigned workpiece receiving position.

4. The workpiece feed device as claimed in claim 3, wherein the signal means has a stop means that can be extended to indicate that a workpiece can be loaded into the workpiece receiving position assigned to the stop means.

5. The workpiece feed device as claimed in claim 3, wherein the signal means has an optical and/or acoustic signal means, by means of which a selected workpiece receiving position can be indicated to indicate that a workpiece can be loaded into the workpiece receiving position indicated by the signal means.

6. A workpiece discharge device having at least one workpiece receiving position for loading a workpiece in the respective workpiece receiving position, and having at least two workpiece removal positions for removing a workpiece having workpiece conveying means for conveying loaded workpieces in a conveying direction from the at least one workpiece receiving position to one of the workpiece removal positions, wherein at least one signal means is provided for signaling a selected workpiece removal position from which a workpiece can be removed.

7. The workpiece discharge device as claimed in claim 6, wherein the at least two workpiece removal positions are arranged adjacently to each other in a direction perpendicular to the conveying direction.

8. The workpiece discharge device as claimed in claim 6, wherein there is assigned to at least one workpiece removal position, or to each apart from one workpiece removal position, or to each workpiece removal position, a signal means that can be activated to indicate that a workpiece can be removed from the assigned workpiece removal position.

9. The workpiece discharge device as claimed in claim 8, wherein the signal means has a stop means that can be retracted or extended to indicate that a workpiece can be removed from the workpiece removal position assigned to the stop means.

10. The workpiece discharge device as claimed in claim 8, wherein the signal means has an optical and/or acoustic signal means, by means of which a selected workpiece removal position can be indicated to indicate that a workpiece can be removed from the workpiece removal position indicated by the signal means.

11. A workpiece transport device, having a workpiece feed device, in particular as claimed in claim 1, and/or having a workpiece discharge device, in particular having at least one workpiece receiving position for loading a workpiece in the respective workpiece receiving position, and having at least two workpiece removal positions for removing a workpiece, having workpiece conveying means for conveying loaded workpieces in a conveying direction from the at least one workpiece receiving position to one of the workpiece removal positions, wherein at least one signal means is provided for signaling a selected workpiece removal position from which a workpiece can be removed.

12. A method for operating a workpiece feed device having at least two workpiece receiving positions for loading a workpiece in the respective workpiece receiving position, and having at least one workpiece removal position for removing a workpiece, having workpiece conveying means for conveying loaded workpieces in a conveying direction from the at least one workpiece receiving position to one of the workpiece removal positions, wherein at least one signal means is provided and controlled to indicate a selected workpiece receiving position in which a workpiece is to be loaded.

13. The method as claimed in claim 12, wherein the signal means has a stop means that is extended to indicate that a workpiece is to be loaded into the workpiece receiving position assigned to the stop means.

14. The method as claimed in claim 12, wherein the signal means has an optical and/or acoustic signal means that is activated to indicate that a workpiece is to be loaded into the workpiece receiving position indicated by the signal means.

15. A method for operating a workpiece discharge device having at least one workpiece receiving position for loading a workpiece in the respective workpiece receiving position, and having at least two workpiece removal positions for removing a workpiece, having workpiece conveying means for conveying loaded workpieces in a conveying direction from the at least one workpiece receiving position to one of the workpiece removal positions, wherein at least one signal means is provided and controlled for signaling a selected workpiece removal position from which a workpiece is to be removed.

16. The method as claimed in claim 15, wherein the signal means has a stop means that is retracted or extended to indicate that a workpiece is to be removed from the workpiece removal position assigned to the stop means.

17. The method as claimed in claim 15, wherein the signal means has an optical and/or acoustic signal means that is controlled to indicate that a workpiece is to be removed from the workpiece removal position indicated by the signal means.
